(19) United States
(12) Patent Application Publication
(10) Pub. No.: US 2022/0234195 A1
(43) Pub. Date: Jul. 28, 2022

(54) CONTROL DEVICE AND LEARNING DEVICE

(71) Applicant: Mitsubishi Electric Corporation, Tokyo (JP)

(72) Inventors: Saori MATSUNAGA, Tokyo (JP); Takuji MORIMOTO, Tokyo (JP); Toshisada MARIYAMA, Tokyo (JP)

(73) Assignee: Mitsubishi Electric Corporation, Tokyo (JP)

(21) Appl. No.: 17/720,835

(22) Filed: Apr. 14, 2022

Related U.S. Application Data
(63) Continuation of application No. PCT/JP2020/005098, filed on Feb. 10, 2020.

(51) Int. Cl. B25J 9/16

(52) U.S. Cl. CPC B25J 9/163

(57) ABSTRACT

A control device: includes a data acquiring unit to acquire inference data including moving speed information indicating a moving speed of an autonomous mobile object, relative position information indicating a relative position of a dynamic obstacle with respect to the autonomous mobile object, and relative speed information indicating a relative speed of the dynamic obstacle with respect to the autonomous mobile object; a control amount calculating unit to calculate a control amount for controlling movement of the autonomous mobile object depending on movement of the dynamic obstacle using the inference data or preprocessed inference data corresponding to the inference data, and a control unit to control the movement of the autonomous mobile object using the control amount. The control amount calculating unit uses a learned model by machine learning, and the learned model receives an input of the inference data or the preprocessed inference data and outputs the control amount.

### CROSS REFERENCE TO RELATED APPLICATIONS

This application is a Continuation of PCT International Application No. PCT/JP2020/005098, filed on Feb. 10, 2020, which is hereby expressly incorporated by reference into the present application.

### TECHNICAL FIELD

The present disclosure relates to a control device and a learning device.

### BACKGROUND ART

Conventionally, a technique for controlling a movement of an autonomous mobile object has been developed. More specifically, a technique of controlling a movement of an autonomous mobile object in such a way as to avoid a moving obstacle (hereinafter, referred to as a “dynamic obstacle”) by predicting a movement of the dynamic obstacle has been developed. Patent Literature 1 discloses such a technique.

### CITATION LIST

### Patent Literature

Patent Literature 1: International Publication No. 2015/068193

### SUMMARY OF INVENTION

### Technical Problem

A conventional technique predicts a movement of a dynamic obstacle on the basis of a predetermined rule, using information collected by sensors. That is, the conventional technique predicts the movement of the dynamic obstacle on the basis of a so-called “rule base”. Therefore, it is required to set a rule for prediction.

In the conventional technique, when a movement of the dynamic obstacle is different from a movement assumed at the time of setting the rule, it is difficult to accurately predict the movement of the dynamic obstacle. Therefore, for example, when the movement of the dynamic obstacle is complicated or the movement of the dynamic obstacle is diverse, it is difficult to accurately predict the movement of the dynamic obstacle. Thus, there has been a problem that it is difficult to correctly control a movement of the autonomous mobile object in response to the movement of the dynamic obstacle. As a result, there has been a problem that, for example, path obstruction to a dynamic obstacle by the autonomous mobile object occurs, or a collision between the autonomous mobile object and the dynamic obstacle occurs.

The present disclosure has been made to solve the above problems, and an object thereof is to correctly control the movement of the autonomous mobile object in response to the movement of the dynamic obstacle.

### Solution to Problem

A control device according to the present disclosure includes: data acquiring circuitry to acquire inference data including moving speed information indicating a moving speed of an autonomous mobile object, relative position information indicating a relative position of a dynamic obstacle with respect to the autonomous mobile object, and relative speed information indicating a relative speed of the dynamic obstacle with respect to the autonomous mobile object; data preprocessing circuitry to generate preprocessed inference data by executing preprocessing on the inference data, the preprocessed inference data including image data indicating a bird's-eye view image of a region including the autonomous mobile object; control amount calculating circuitry to calculate a control amount for controlling a movement of the autonomous mobile object in response to a movement of the dynamic obstacle using the preprocessed inference data, and control circuitry to control the movement of the autonomous mobile object using the control amount, in which the data preprocessing circuitry sets a size of the region indicated by the image data depending on the moving speed and the relative speed, the control amount calculating circuitry uses a learned model by machine learning, and the learned model receives an input of the preprocessed inference data and outputs the control amount.

### Advantageous Effects of Invention

According to the present disclosure, with the above configuration, the movement of the autonomous mobile object can be correctly controlled in response to the movement of the dynamic obstacle.

### BRIEF DESCRIPTION OF DRAWINGS

FIG. 1 is a block diagram illustrating a main part of a control device according to a first embodiment.

FIG. 2 is a block diagram illustrating a main part of a learning device according to the first embodiment.

FIG. 3 is an explanatory diagram illustrating an example of a bird's-eye view image.

FIG. 4 is an explanatory diagram illustrating an example of a neural network.

FIG. 5 is a block diagram illustrating a hardware configuration of the main part of the control device according to the first embodiment.

FIG. 6 is a block diagram illustrating another hardware configuration of the main part of the control device according to the first embodiment.

FIG. 7 is a block diagram illustrating another hardware configuration of the main part of the control device according to the first embodiment.

FIG. 8 is a block diagram illustrating a hardware configuration of the main part of the learning device according to the first embodiment.

FIG. 9 is a block diagram illustrating another hardware configuration of the main part of the learning device according to the first embodiment.

FIG. 10 is a block diagram illustrating another hardware configuration of the main part of the learning device according to the first embodiment.

FIG. 11 is a flowchart illustrating the operation of the control device according to the first embodiment.

FIG. 12 is a flowchart illustrating the operation of the learning device according to the first embodiment.

FIG. 13 is a block diagram illustrating a main part of another control device according to the first embodiment.

FIG. 14 is a block diagram illustrating a main part of another learning device according to the first embodiment.

FIG. 15 is a block diagram illustrating a main part of another learning device according to the first embodiment.

FIG. 16 is a block diagram illustrating a main part of another learning device according to the first embodiment.

### DESCRIPTION OF EMBODIMENTS

In order to explain this disclosure in more detail, a mode for carrying out this disclosure will be described below with reference to the accompanying drawings.

### First Embodiment

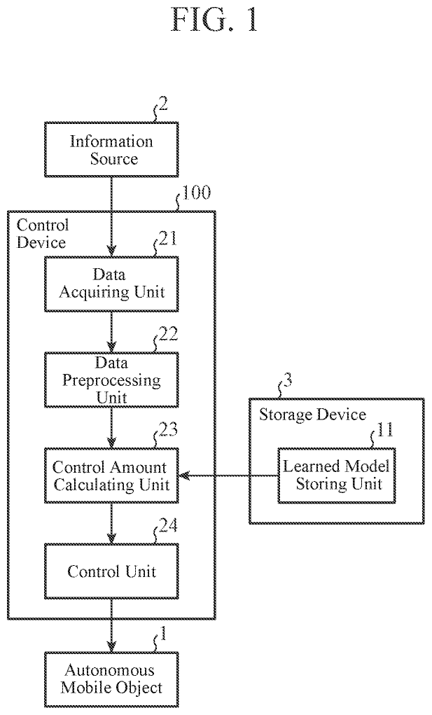

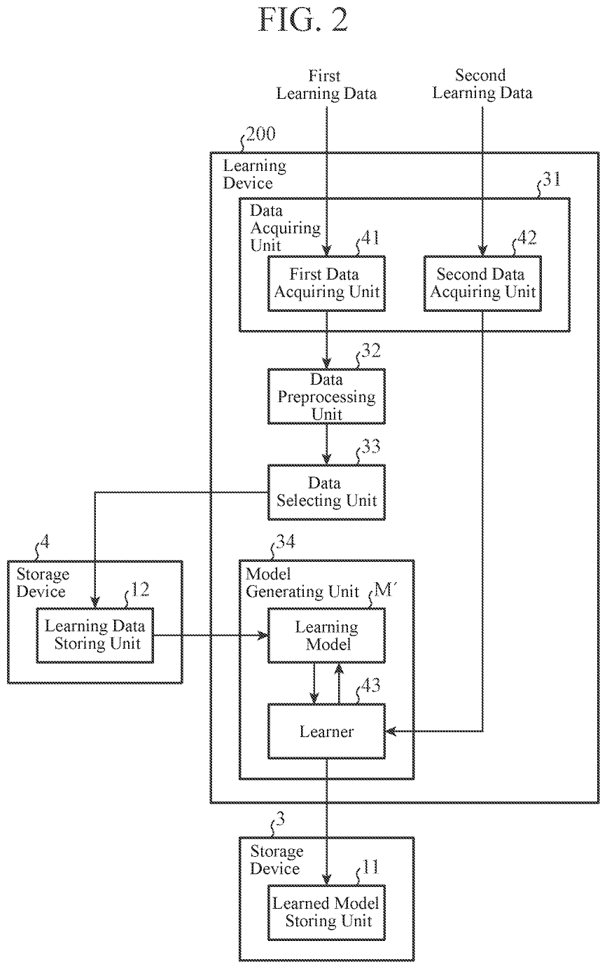

FIG. 1 is a block diagram illustrating a main part of a control device according to a first embodiment. FIG. 2 is a block diagram illustrating a main part of a learning device according to the first embodiment. The control device according to the first embodiment will be described with reference to FIG. 1. Furthermore, the learning device according to the first embodiment will be described with reference to FIG. 2.

As illustrated in FIG. 1, a control device 100 includes a data acquiring unit 21, a data preprocessing unit 22, a control amount calculating unit 23, and a control unit 24.

The data acquiring unit 21 acquires data (hereinafter referred to as “inference data”) D1 including information (hereinafter, referred to as “moving speed information”) indicating a moving speed V1 of an autonomous mobile object 1, information (hereinafter, referred to as “relative position information”) indicating a relative position P of each of dynamic obstacles O with respect to the autonomous mobile object 1, and information (hereinafter, referred to as “relative speed information”) indicating a relative speed V2 of each of the dynamic obstacles O with respect to the autonomous mobile object 1.

More specifically, the inference data D1 includes moving speed information indicating a plurality of moving speeds V1 corresponding to a plurality of consecutive times T, relative position information indicating a plurality of relative positions P corresponding to the plurality of consecutive times T, and relative speed information indicating a plurality of relative speeds V2 corresponding to the plurality of consecutive times T. That is, the inference data D1 is formed by associating the plurality of moving speeds V1, the plurality of relative positions P, and the plurality of relative speeds V2 in time series. In other words, the inference data D1 includes time-series data.

The inference data D1 is acquired using an information source 2. The information source 2 includes, for example, a laser radar, a camera, a millimeter-wave radar, a sonar, an inertial sensor, a global positioning system (GPS) receiver, and a wheel speed sensor. That is, the information source 2 may be mounted on the autonomous mobile object 1.

The autonomous mobile object 1 is, for example, an unmanned carrier vehicle that travels in a factory. On the other hand, each of the dynamic obstacles O is, for example, a manned mobile object for work traveling in the same factory or a worker moving in the same factory. The manned mobile object for work is, for example, a forklift. Hereinafter, an example in which the autonomous mobile object 1 is an unmanned carrier vehicle and each of the dynamic obstacles O is a manned mobile object for work or a worker will be mainly described.

The data preprocessing unit 22 executes preprocessing on the inference data D1, thereby generating preprocessed data (hereinafter referred to as “preprocessed inference data”) D2. The preprocessed inference data D2 includes image data D3 indicating a bird's-eye view image I1 of a region R including the autonomous mobile object 1.

More specifically, the image data D3 indicates a plurality of bird's-eye view images I1 corresponding to the plurality of consecutive times T. That is, the image data D3 includes time-series data. As a result, the image data D3 indicates a temporal change of the relative position P and a temporal change of the relative speed V2 for each of the dynamic obstacles O. In other words, the image data D3 indicates the movement of each of the dynamic obstacles O.

Here, a method of generating the bird's-eye view image I1 will be described.

First, the data preprocessing unit 22 generates the following image I2 using the inference data D1. That is, the data preprocessing unit 22 generates the image I2 that is centered on a position of the autonomous mobile object 1 and that is obtained at an angle looking down from directly above a plane on which the autonomous mobile object 1 moves.

In the image I2, the autonomous mobile object 1 may be expressed by an abstract illustration i1. In the image I2, each of the dynamic obstacles O may be expressed by an abstract illustration i2. Each pixel in the image I2 may have a color value, a luminance value, or a color value and a luminance value. That is, the image I2 may be a color image or a monochrome image.

Next, the data preprocessing unit 22 generates the bird's-eye view image I1 by cutting out a portion corresponding to the region R in the image I2. At this time, the range to be cut out is set depending on the moving speed V1 and the relative speed V2. That is, the size of the region R is set depending on the moving speed V1 and the relative speed V2.

FIG. 3 illustrates an example of the bird's-eye view image I1 generated in this manner. In the example illustrated in FIG. 3, the autonomous mobile object 1 is expressed by a quadrangular illustration i1. In addition, one dynamic obstacle O is expressed by a circular illustration i2.

By using the image data D3 generated in this manner, even when a plurality of dynamic obstacles O is present around the autonomous mobile object 1, the relative position P of each of the dynamic obstacles O and the relative speed V2 of each of the dynamic obstacles O can be simply expressed.

The control amount calculating unit 23 calculates a control amount A for controlling the movement of the autonomous mobile object 1 in response to the movement of the dynamic obstacle O, using the preprocessed inference data D2. More specifically, the control amount calculating unit 23 calculates a control amount A for avoiding occurrence of path obstruction to the dynamic obstacle O by the autonomous mobile object 1, or a control amount A for avoiding occurrence of collision between the autonomous mobile object 1 and the dynamic obstacle O. As a result, the control amount A for avoiding the occurrence of work obstruction to the dynamic obstacle O by the autonomous mobile object 1 is calculated.

Here, the control amount calculating unit 23 uses a learned model M by machine learning. The learned model M is stored in a learned model storing unit 11 of a storage device 3. The storage device 3 includes a memory. The learned model M receives an input of the preprocessed inference data D2 and outputs the control amount A as described above.

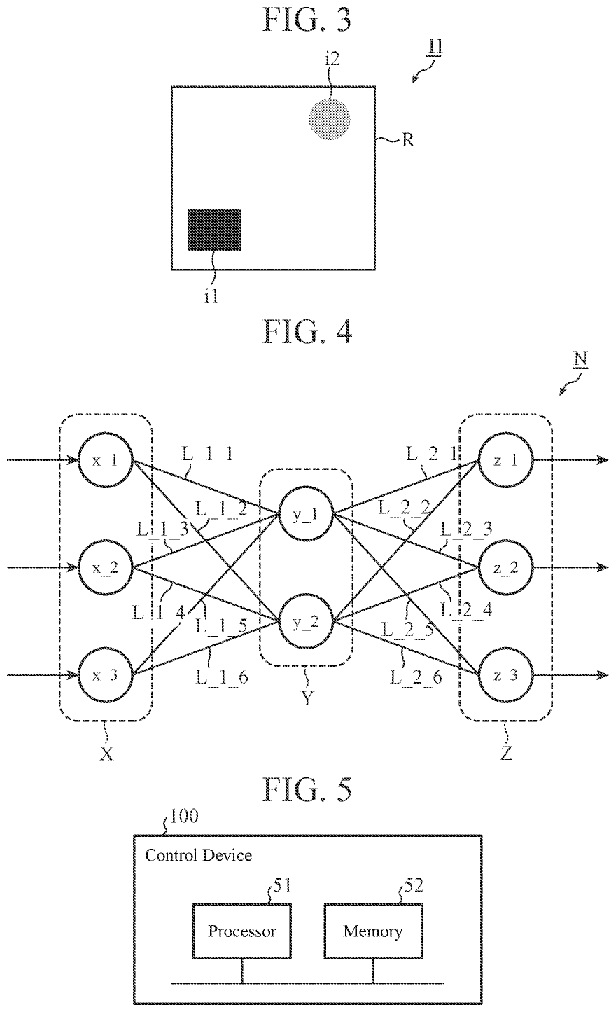

The learned model M includes, for example, a neural network N. FIG. 4 illustrates an example of the neural network N.

As illustrated in FIG. 4, the neural network N includes an input layer X, an intermediate layer (so-called “hidden layer”) Y, and an output layer Z. The input layer X has a plurality of nodes x_1 to x_3. The intermediate layer Y has a plurality of nodes y_1 and y_2. The output layer Z has a plurality of nodes z_1 to z_3. A link L_1 between the input layer X and the intermediate layer Y corresponds to a weight W_1. More specifically, a plurality of links L_1_1 to L_1_6 correspond to a plurality of weights W_1_1 to W_1_6, respectively. A link L_2 between the intermediate layer Y and the output layer Z corresponds to a weight W_2. More specifically, a plurality of links L_2_1 to L_2_6 correspond to a plurality of weights W_2_1 to W_2_6, respectively.

Each of the nodes x, y, and z corresponds to an operation of adding input values. In addition, each of the links L corresponds to an operation of multiplying the corresponding weight W. Therefore, the correspondence relationship between the value input to the input layer X and the value output by the output layer Z varies depending on each of the weights W Note that the neural network N may have a plurality of intermediate layers Y.

The control unit 24 controls the movement of the autonomous mobile object 1 using the control amount A calculated by the control amount calculating unit 23 (that is, the control amount A output by the learned model M). As a result, the movement of the autonomous mobile object 1 is controlled in response to the movement of the dynamic obstacle O.

Specifically, for example, the control unit 24 executes control to operate a steering in the autonomous mobile object 1 on the basis of the control amount A. Alternatively, for example, the control unit 24 executes control to operate a brake in the autonomous mobile object 1 on the basis of the control amount A. As a result, the movement of the autonomous mobile object 1 is controlled in such a way as to avoid occurrence of path obstruction to the dynamic obstacle O by the autonomous mobile object 1 or in such a way as to avoid occurrence of collision between the autonomous mobile object 1 and the dynamic obstacle O. As a result, the movement of the autonomous mobile object 1 is controlled in such a way as to avoid the occurrence of work obstruction to the dynamic obstacle O by the autonomous mobile object 1.

Note that the control device 100 may be mounted on the autonomous mobile object 1. Alternatively, the control device 100 may be provided outside the autonomous mobile object 1 and freely communicable with the autonomous mobile object 1. That is, the control device 100 may include, for example, a server that freely communicates with the autonomous mobile object 1. Such a server may use a cloud server. The same applies to the storage device 3.

As illustrated in FIG. 2, a learning device 200 includes a data acquiring unit 31, a data preprocessing unit 32, a data selecting unit 33, and a model generating unit 34. The data acquiring unit 31 has a first data acquiring unit 41 and a second data acquiring unit 42. The model generating unit 34 has a learning model M′ and a learner 43.

The first data acquiring unit 41 acquires data (hereinafter, referred to as “first learning data”) D11 including information indicating a moving speed V1′ of the autonomous mobile object 1 (that is, moving speed information), information indicating a relative position P′ of each of dynamic obstacles O′ with respect to the autonomous mobile object 1 (that is, relative position information), and information indicating a relative speed V2′ of each of the dynamic obstacles O′ with respect to the autonomous mobile object 1 (that is, relative speed information).

More specifically, the first learning data D11 includes moving speed information indicating a plurality of moving speeds V1′ corresponding to a plurality of consecutive times T′, relative position information indicating a plurality of relative positions P′ corresponding to the plurality of consecutive times T′, and relative speed information indicating a plurality of relative speeds V2′ corresponding to the plurality of consecutive times T′. That is, the first learning data D11 is formed by associating a plurality of moving speeds V1′, a plurality of relative positions P′, and a plurality of relative speeds V2′ in time series. In other words, the first learning data D11 includes time-series data.

The second data acquiring unit 42 acquires data (hereinafter, referred to as “second learning data”) D12 including a correct value of a control amount A′ in a state corresponding to the first learning data D11. More specifically, the second learning data D12 includes a correct value of the control amount A′ for controlling the movement of the autonomous mobile object 1 in response to the movement of the dynamic obstacle O′. That is, the second learning data D12 includes a correct value of the control amount A′ for avoiding the occurrence of the path obstruction to the dynamic obstacle O′ by the autonomous mobile object 1 or a correct value of the control amount A′ for avoiding occurrence of collision between the autonomous mobile object 1 and the dynamic obstacle O′. In other words, the second learning data D12 includes a correct value of the control amount A′ for avoiding occurrence of work obstruction to the dynamic obstacle O′ by the autonomous mobile object 1.

The first learning data D11 is collected using an actual machine of the autonomous mobile object 1, for example. Alternatively, the first learning data D11 is collected using a dedicated simulator, for example. On the other hand, the second learning data D12 is input by a person, for example.

The data preprocessing unit 32 executes preprocessing on the first learning data D11, thereby generating preprocessed data (hereinafter, referred to as “preprocessed learning data”) D13. The preprocessed learning data D13 includes image data D14 indicating a bird's-eye view image I11 of a region R including the autonomous mobile object 1.

More specifically, the image data D14 indicates a plurality of bird's-eye view images I11 corresponding to the plurality of consecutive times T′. That is, the image data D14 includes time-series data. As a result, the image data D14 indicates a temporal change of the relative position P′ and a temporal change of the relative speed V2′ for each of the dynamic obstacles O′. In other words, the image data D14 indicates the movement of each of the dynamic obstacles O′.

A method of generating the bird's-eye view image I11 by the data preprocessing unit 32 is similar to the method of generating the bird's-eye view image I1 by the data preprocessing unit 22. Therefore, detailed description is omitted.

The data selecting unit 33 selects unnecessary data (hereinafter referred to as “unnecessary data”) D15 from among the preprocessed learning data D13. Here, the unnecessary data D15 includes data corresponding to a state in which the work obstruction to the dynamic obstacle O′ by the autonomous mobile object 1 cannot occur (hereinafter, referred to as a “non-occurrence state”). Specifically, for example, the unnecessary data D15 includes the image data D14 indicating the bird's-eye view image I11 that does not include any dynamic obstacle O′.

The data selecting unit 33 outputs data (hereinafter, may be referred to as “selected learning data”) D16 obtained by excluding the unnecessary data D15 from the preprocessed learning data D13. The output selected learning data D16 is stored in a learning data storing unit 12 of a storage device 4. The storage device 4 includes a memory.

The learning model M′ receives an input of the selected learning data D16. The learning model M′ outputs the control amount A′ for such an input. The learning model M′ includes a neural network N, for example.

Here, the learning model M′ can freely learn by machine learning. More specifically, the learning model M′ can freely learn by so-called “imitation learning”. The learner 43 trains the learning model M′ using the second learning data D12 and the control amount A′.

That is, the learner 43 compares the control amount A′ output by the learning model M′ with the correct value indicated by the second learning data D12. The learner 43 selects one or more parameters among a plurality of parameters in the learning model M′ depending on the comparison result and updates the values of the selected parameters. Each of the parameters in the learning model M′ corresponds to, for example, the weight W in the neural network N.

At this time, the learner 43 updates the value of the parameter in such a way that the control amount A′ output by the learning model M′ gradually approaches the correct value. By such learning, the learned model M as described above is generated. That is, the learned model M that receives the input of the inference data D1 and outputs the control amount A for avoiding the occurrence of the work obstruction to the dynamic obstacle O by the autonomous mobile object 1 is generated. The learner 43 outputs the generated learned model M. The output learned model M is stored in the learned model storing unit 11 of the storage device 3.

Note that the learning device 200 may be mounted on the autonomous mobile object 1. Alternatively, the learning device 200 may be provided outside the autonomous mobile object 1 and freely communicable with the autonomous mobile object 1. That is, the learning device 200 may include, for example, a server that freely communicates with the autonomous mobile object 1. Such a server may use a cloud server. The same applies to the storage device 4.

Hereinafter, a reference sign “F1” may be used for the function of the data acquiring unit 21. In addition, a reference sign “F2” may be used for the function of the data preprocessing unit 22. In addition, a reference sign “F3” may be used for the function of the control amount calculating unit 23. In addition, a reference sign “F4” may be used for the function of the control unit 24.

Hereinafter, a reference sign “F11” may be used for the function of the data acquiring unit 31. In addition, a reference sign “F12” may be used for the function of the data preprocessing unit 32. In addition, a reference sign “F13” may be used for the function of the data selecting unit 33. In addition, a reference sign “F14” may be used for the function of the model generating unit 34.

Hereinafter, processing executed by the data acquiring unit 21 may be collectively referred to as “data acquisition processing”. In addition, processing executed by the data preprocessing unit 22 may be collectively referred to as “data preprocessing”. In addition, processing executed by the control amount calculating unit 23 may be collectively referred to as “control amount calculation processing”. In addition, processing and control executed by the control unit 24 may be collectively referred to as “mobile object control”.

Hereinafter, processing executed by the data acquiring unit 31 may be collectively referred to as “data acquisition processing”. In addition, processing executed by the data preprocessing unit 32 may be collectively referred to as “data preprocessing”. In addition, processing executed by the data selecting unit 33 may be collectively referred to as “data selection processing”. In addition, processing executed by the model generating unit 34 may be collectively referred to as “model generation processing”.

Next, a hardware configuration of the main part of the control device 100 will be described with reference to FIGS. 5 to 7.

The control device 100 has, as shown in FIG. 5, a processor 51 and a memory 52. The memory 52 stores programs corresponding to a plurality of functions F1 to F4. The processor 51 reads and executes the programs stored in the memory 52. As a result, the plurality of functions F1 to F4 are implemented.

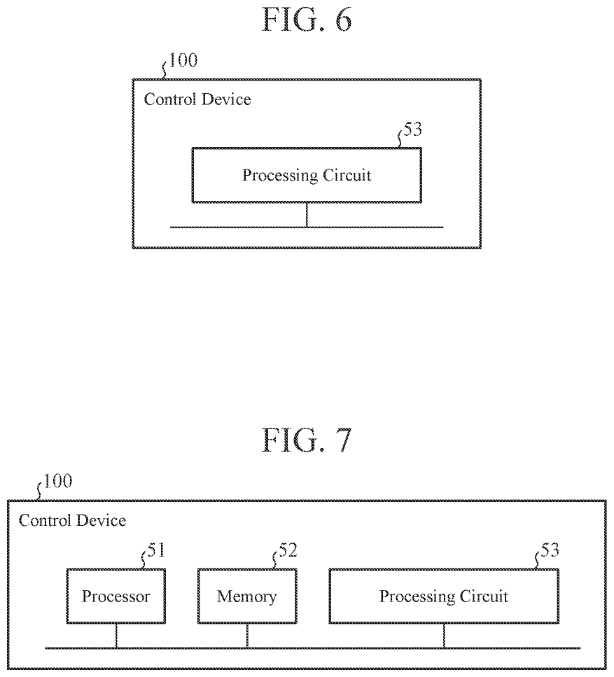

Alternatively, as shown in FIG. 6, the control device 100 has a processing circuit 53. The processing circuit 53 executes processing corresponding to the plurality of functions F1 to F4. As a result, the plurality of functions F1 to F4 are implemented.

Alternatively, as illustrated in FIG. 7, the control device 100 has the processor 51, the memory 52, and the processing circuit 53. The memory 52 stores programs corresponding to some of the plurality of functions F1 to F4. The processor 51 reads and executes the programs stored in the memory 52. As a result, some of the functions are implemented. In addition, the processing circuit 53 executes processing corresponding to the remaining functions among the plurality of functions F1 to F4. As a result, the remaining functions are implemented.

The processor 51 includes one or more processors. Each of the processors uses, for example, a central processing unit (CPU), a graphics processing unit (GPU), a microprocessor, a microcontroller, or a digital signal processor (DSP).

The memory 52 includes one or more nonvolatile memories. Alternatively, the memory 52 includes one or more nonvolatile memories and one or more volatile memories. That is, the memory 52 includes one or more memories. Each of the memories uses, for example, a semiconductor memory, a magnetic disk, an optical disk, a magneto-optical disk, a magnetic tape, or a magnetic drum. More specifically, each of the volatile memories uses, for example, a random access memory (RAM). In addition, each of the nonvolatile memories uses, for example, a read only memory (ROM), a flash memory, an erasable programmable read only memory (EPROM), an electrically erasable programmable read only memory (EEPROM), a solid state drive, a hard disk drive, a flexible disk, a compact disk, a digital versatile disc (DVD), a Blu-ray disk, or a mini disk.

The processing circuit 53 includes one or more digital circuits. Alternatively, the processing circuit 53 includes one or more digital circuits and one or more analog circuits. That is, the processing circuit 53 includes one or more processing circuits. Each of the processing circuits uses, for example, an application specific integrated circuit (ASIC), a programmable logic device (PLD), a field programmable gate array (FPGA), a system on a chip (SoC), or a system large scale integration (LSI).

Here, when the processor 51 includes a plurality of processors, the correspondence relationship between the plurality of functions F1 to F4 and the plurality of processors is arbitrary. That is, each of the plurality of processors may read and execute programs corresponding to one or more corresponding functions among the plurality of functions F1 to F4.

In addition, when the memory 52 includes a plurality of memories, the correspondence relationship between the plurality of functions F1 to F4 and the plurality of memories is arbitrary. That is, each of the plurality of memories may store programs corresponding to one or more corresponding functions among the plurality of functions F1 to F4.

In addition, when the processing circuit 53 includes a plurality of processing circuits, the correspondence relationship between the plurality of functions F1 to F4 and the plurality of processing circuits is arbitrary. That is, each of the plurality of processing circuits may execute processing corresponding to one or more corresponding functions among the plurality of functions F1 to F4.

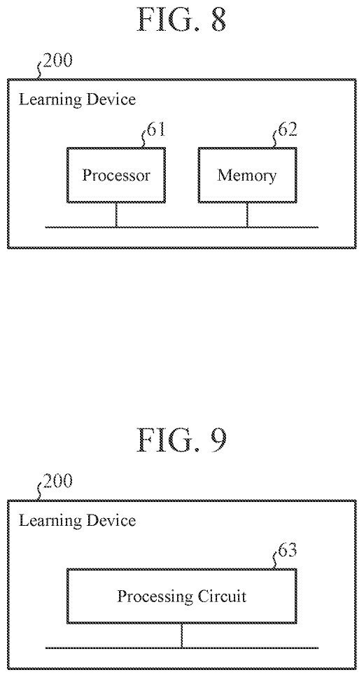

Next, a hardware configuration of the main part of the learning device 200 will be described with reference to FIGS. 8 to 10.

As illustrated in FIG. 8, the learning device 200 has a processor 61 and a memory 62. The memory 62 stores programs corresponding to a plurality of functions F11 to F14. The processor 61 reads and executes the programs stored in the memory 62. As a result, the plurality of functions F11 to F14 are implemented.

Alternatively, as illustrated in FIG. 9, the learning device 200 has a processing circuit 63. The processing circuit 63 executes processing corresponding to the plurality of functions F11 to F14. As a result, the plurality of functions F11 to F14 are implemented.

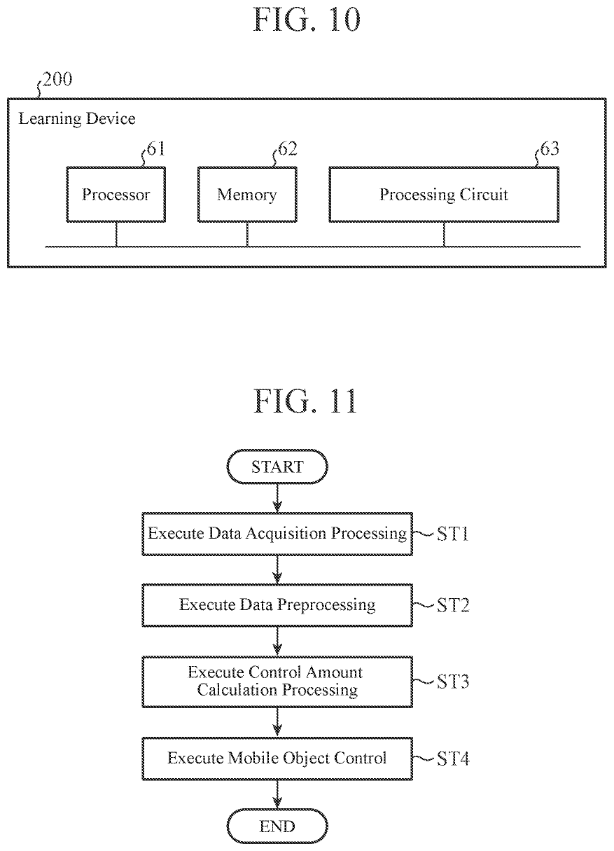

Alternatively, as illustrated in FIG. 10, the learning device 200 has the processor 61, the memory 62, and the processing circuit 63. The memory 62 stores programs corresponding to some of the functions F11 to F14. The processor 61 reads and executes the programs stored in the memory 62. As a result, some of the functions are implemented. In addition, the processing circuit 63 executes processing corresponding to the remaining functions among the plurality of functions F11 to F14. As a result, the remaining functions are implemented.

A specific example of the processor 61 is similar to the specific example of the processor 51. A specific example of the memory 62 is similar to the specific example of the memory 52. A specific example of the processing circuit 63 is similar to the specific example of the processing circuit 53. Therefore, detailed description is omitted.

Here, when the processor 61 includes a plurality of processors, the correspondence relationship between the plurality of functions F1 to F14 and the plurality of processors is arbitrary. That is, each of the plurality of processors may read and execute programs corresponding to one or more corresponding functions among the plurality of functions F1 to F14.

When the memory 62 includes a plurality of memories, the correspondence relationship between the plurality of functions F11 to F14 and the plurality of memories is arbitrary. That is, each of the plurality of memories may store programs corresponding to one or more corresponding functions among the plurality of functions F11 to F14.

In addition, w % ben the processing circuit 63 includes a plurality of processing circuits, the correspondence relationship between the plurality of functions F11 to F14 and the plurality of processing circuits is arbitrary. That is, each of the plurality of processing circuits may execute processing corresponding to one or more corresponding functions among the plurality of functions F11 to F14.

Next, the operation of the control device 100 will be described with reference to a flowchart of FIG. 11.

First, the data acquiring unit 21 executes data acquisition processing (step ST1). Next, the data preprocessing unit 22 executes data preprocessing (step ST2). Next, the control amount calculating unit 23 executes control amount calculation processing (step ST3). Next, the control unit 24 executes mobile object control (step ST4).

Note that, in a case where none of the dynamic obstacles O is included in all the bird's-eye view images I1 generated in step ST2, the control device 100 may cancel the execution of the processing of steps ST3 and ST4. In this case, the processing of the control device 100 may return to step ST1.

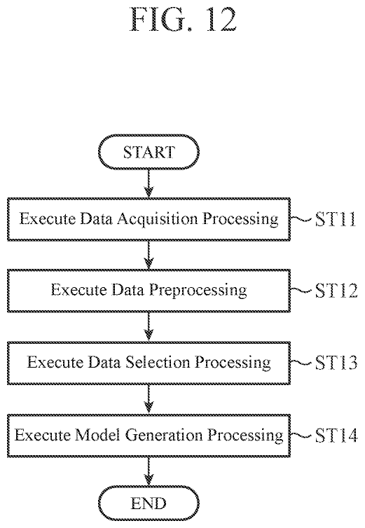

Next, the operation of the learning device 200 will be described with reference to a flowchart of FIG. 12.

First, the data acquiring unit 31 executes data acquisition processing (step ST11). Next, the data preprocessing unit 32 executes data preprocessing (step ST12). Next, the data selecting unit 33 executes data selection processing (step ST13). Next, the model generating unit 34 executes model generation processing (step ST14).

Note that the first learning data D11 and the second learning data D12 may be acquired at different timings. That is, the first learning data D11 and the second learning data D12 may be acquired in different steps.

In addition, in a case where all the data included in the preprocessed learning data D13 is selected as the unnecessary data D15 in step ST3, the learning device 200 may cancel the execution of the processing of step ST14.

Next, effects of the control device 100 and the learning device 200 will be described.

Conventional control devices are based on rules. That is, the conventional control device predicts the movement of the dynamic obstacle on the basis of a predetermined rule, and controls the movement of the autonomous mobile object in response to the predicted movement. Therefore, there has been a problem that it is required to set a rule for prediction.

In addition, in the rule base, in a case where the movement of the dynamic obstacle is different from the movement assumed at the time of setting the rule, it is difficult to accurately predict the movement of the dynamic obstacle. In particular, for example, when the movement of the dynamic obstacle is complex or when the movement of the dynamic obstacle is diverse, it is difficult to accurately predict the movement of the dynamic obstacle. For this reason, there has been a problem that it is difficult to correctly control the movement of the autonomous mobile object in response to the movement of the dynamic obstacle. As a result, there has been a problem that, for example, path obstruction to the dynamic obstacle by the autonomous mobile object occurs, or a collision between the autonomous mobile object and the dynamic obstacle occurs.

On the other hand, the control device 100 uses the learned model M obtained by the learning device 200. Therefore, setting of the rule for prediction can be made unnecessary.

In addition, even when the movement of the dynamic obstacle O is an unexpected movement, the movement of the autonomous mobile object 1 can be correctly controlled in response to the movement of the dynamic obstacle O.

Therefore, for example, even when the movement of the dynamic obstacle O is complicated or the movement of the dynamic obstacle O is diverse, the movement of the autonomous mobile object 1 can be correctly controlled in response to the movement of the dynamic obstacle O.

As a result, it is possible to avoid occurrence of path obstruction to the dynamic obstacle O by the autonomous mobile object 1. In addition, it is possible to avoid occurrence of collision between the autonomous mobile object 1 and the dynamic obstacle O. As a result, it is possible to avoid occurrence of work obstruction to the dynamic obstacle O by the autonomous mobile object 1. Therefore, it is possible to improve work efficiency of a manned mobile object for work (for example, a forklift) or a worker.

Next, modifications of the control device 100 and the learning device 200 will be described.

The autonomous mobile object 1 is not limited to an unmanned carrier vehicle that travels in a factory. The autonomous mobile object 1 only needs to autonomously move in an environment including one or more dynamic obstacles O. For example, the autonomous mobile object 1 may be an autonomous vehicle, a robot cleaner, a service robot, or a robot arm. The robot arm may be provided for a factory automation (FA) device.

Here, in a factory where automatic work by the FA device and manual work by the worker are performed, the robot arm of the FA device may be the autonomous mobile object 1, and the arm of the worker may be the dynamic obstacle O. This makes it possible to avoid occurrence of work obstruction to the worker by the robot arm. As a result, the work efficiency of the worker can be improved. In other words, manual work by the worker can be prioritized over automatic work by the FA device.

Next, another modification of the control device 100 and the learning device 200 will be described.

In addition to the moving speed information, the relative position information, and the relative speed information, the inference data D1 may include other information related to a work by each of the dynamic obstacles O or other information related to a moving route of each of the dynamic obstacles O. In addition, the first learning data D11 may include information corresponding to these pieces of information. By additionally using these pieces of information, it is possible to more reliably avoid occurrence of work obstruction by the autonomous mobile object 1.

For example, when the autonomous mobile object 1 is an unmanned carrier vehicle and the dynamic obstacle O is a forklift, the inference data D1 may include information indicating the presence or absence of an occupant in the forklift, information indicating the position of the forks in the forklift, information indicating the position of lamps for the forklift, and the like. In addition, the first learning data D11 may include information corresponding to these pieces of information.

In addition, for example, when the autonomous mobile object 1 is a robot arm of the FA device and the dynamic obstacle O is an arm of the worker, the inference data D1 may include information indicating a posture of the arm of the worker, and the like. In addition, the first learning data D11 may include information corresponding to these pieces of information.

Next, another modification of the control device 100 and the learning device 200 will be described.

The image indicated by the image data D3 may indicate the relative position P and the relative speed V2. That is, the image indicated by the image data D3 is not limited to the bird's-eye view image I1. The image indicated by the image data D3 may be obtained at any angle. The same applies to the image data D14.

For example, when the autonomous mobile object 1 is a robot arm of the FA device and the dynamic obstacle O is an arm of the worker, the image indicated by the image data D3 may be obtained at an angle at which the image includes the robot arm and the arm of the worker. The same applies to the image data D14.

Next, another modification of the learning device 200 will be described.

The learning method of the learning model M′ by the learner 43 is not limited to the above specific example. Various known techniques related to machine learning can be used for learning of the learning model M′. For example, various known techniques related to supervised learning, unsupervised learning, or reinforcement learning can be used. Detailed description of these techniques is omitted.

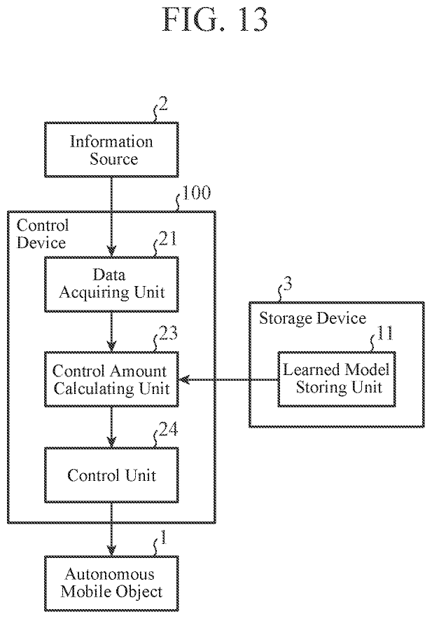

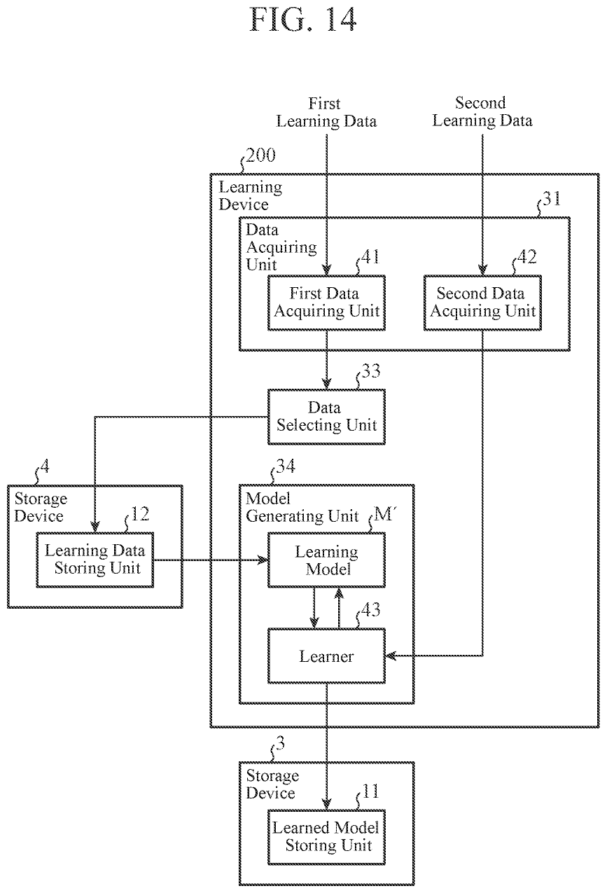

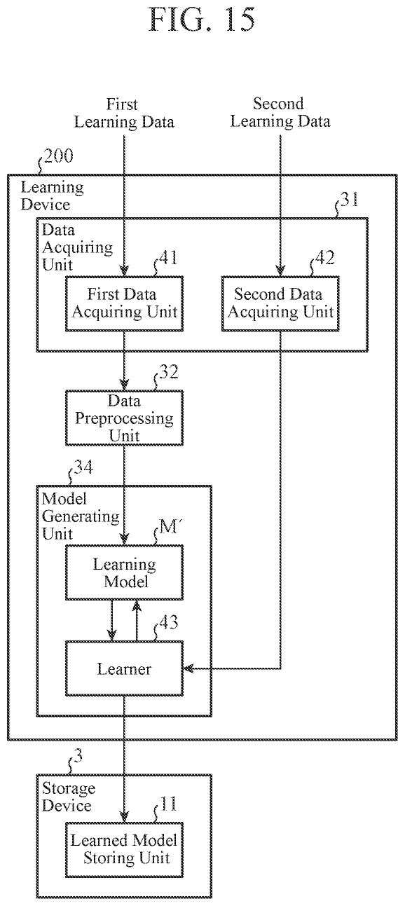

Next, another modification of the control device 100 and the learning device 200 will be described with reference to FIGS. 13 and 14.

As illustrated in FIG. 13, the control device 100 need not necessarily include the data preprocessing unit 22. In this case, the control amount calculating unit 23 may calculate the control amount A using the inference data D1. That is, the learned model M may receive an input of the inference data D1 and output the control amount A.

As illustrated in FIG. 14, the learning device 200 need not necessarily include the data preprocessing unit 32. In this case, the data selecting unit 33 may select the unnecessary data D15 included in the first learning data D11. The selected learning data D16 may include data excluding the unnecessary data D15 in the first learning data D11.

Next, another modification of the learning device 200 will be described with reference to FIG. 15.

As illustrated in FIG. 15, the learning device 200 need not necessarily include the data selecting unit 33. In this case, the learning model M′ may receive an input of the preprocessed learning data D13 and output the control amount A′. In this regard, it is more preferable to provide the data selecting unit 33, from the viewpoint of preventing the unnecessary data D15 from being used for learning of the learning model M′.

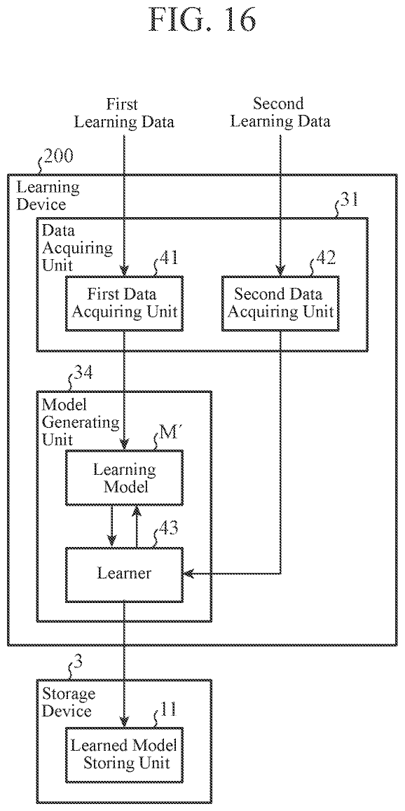

Next, another modification of the learning device 200 will be described with reference to FIG. 16.

As illustrated in FIG. 16, the learning device 200 need not necessarily include the data preprocessing unit 32 and the data selecting unit 33. In this case, the learning model M′ may receive an input of the first learning data D11 and output the control amount A′. In this regard, it is more preferable to provide the data selecting unit 33, from the viewpoint of preventing the unnecessary data D15 from being used for learning of the learning model M′.

As described above, the control device 100 according to the first embodiment includes: the data acquiring unit 21 to acquire the inference data D1 including the moving speed information indicating the moving speed V1 of the autonomous mobile object 1, the relative position information indicating the relative position P of the dynamic obstacle O with respect to the autonomous mobile object 1, and the relative speed information indicating the relative speed V2 of the dynamic obstacle O with respect to the autonomous mobile object 1; the control amount calculating unit 23 to calculate the control amount A for controlling the movement of the autonomous mobile object 1 in response to the movement of the dynamic obstacle O using the inference data D1 or the preprocessed inference data D2 corresponding to the inference data D1; and the control unit 24 to control the movement of the autonomous mobile object 1 using the control amount A. The control amount calculating unit 23 uses the learned model M by machine learning, and the learned model M receives an input of the inference data D1 or the preprocessed inference data D2 and outputs the control amount A. As a result, the movement of the autonomous mobile object 1 can be correctly controlled in response to the movement of the dynamic obstacle O. In particular, even when the movement of the dynamic obstacle O is complicated or the movement of the dynamic obstacle O is diverse, the movement of the autonomous mobile object 1 can be correctly controlled.

In addition, the dynamic obstacle O includes a manned mobile object for work or a worker, and the learned model M outputs the control amount A for avoiding occurrence of work obstruction to the manned mobile object or the worker by the autonomous mobile object 1. This makes it possible to avoid occurrence of work obstruction by the autonomous mobile object 1. As a result, it is possible to improve work efficiency of the manned mobile object for work (for example, a forklift) or the worker.

In addition, the control device 100 includes the data preprocessing unit 22 to generate the preprocessed inference data D2 by executing preprocessing on the inference data D1, and the preprocessed inference data D2 includes the image data D3 indicating the bird's-eye view image I1 of the region R including the autonomous mobile object 1. As a result, the image data D3 can be used as an input to the learned model M.

Further, the autonomous mobile object 1 is provided for an FA device, the dynamic obstacle O includes an arm of a worker in a factory having the FA device, and the learned model M outputs the control amount A for avoiding occurrence of work obstruction to the worker by the autonomous mobile object 1. This makes it possible to avoid occurrence of work obstruction by the autonomous mobile object 1 (for example, a robot arm). As a result, the work efficiency of the worker can be improved.

In addition, the learned model M outputs the control amount A for avoiding occurrence of path obstruction to the dynamic obstacle O by the autonomous mobile object 1. As a result, for example, the occurrence of work obstruction as described above can be avoided.

In addition, the learned model M outputs the control amount A for avoiding occurrence of collision between the autonomous mobile object 1 and the dynamic obstacle O. As a result, for example, the occurrence of work obstruction as described above can be avoided.

In addition, the learning device 200 according to the first embodiment includes: the data acquiring unit 31 to acquire the first learning data D11 including the moving speed information indicating the moving speed V1′ of the autonomous mobile object 1, the relative position information indicating the relative position P′ of the dynamic obstacle O′ with respect to the autonomous mobile object 1, and the relative speed information indicating the relative speed V2′ of the dynamic obstacle O′ with respect to the autonomous mobile object 1, and acquire the second learning data D12 including the correct value of the control amount A′ for controlling the movement of the autonomous mobile object 1 in response to the movement of the dynamic obstacle O′; and the model generating unit 34 including the learning model M′ to receive the input of the first learning data D11 or the preprocessed learning data D13 corresponding to the first learning data D11 and output the control amount A′, and the learner 43 to generate the learned model M by training the learning model M′ using the second learning data D12, in which the learned model M receives the input of the inference data D1 including the moving speed information, the relative position information, and the relative speed information or the preprocessed inference data D2 corresponding to the inference data D1, and outputs the control amount A. This makes it possible to implement the control device 100. As a result, the movement of the autonomous mobile object 1 can be correctly controlled in response to the movement of the dynamic obstacle O.

In addition, the dynamic obstacle O′ includes a manned mobile object for work or a worker, and the correct value indicates the control amount A′ for avoiding the occurrence of work obstruction to the manned mobile object or the worker by the autonomous mobile object 1. This makes it possible to avoid occurrence of work obstruction by the autonomous mobile object 1. As a result, it is possible to improve work efficiency of a manned mobile object for work (for example, a forklift) or a worker.

In addition, the learning device 200 includes the data selecting unit 33 to select the unnecessary data D15 included in the first learning data D11 or the preprocessed learning data D13, and the unnecessary data D15 is excluded from training of the learning model M′. This makes it possible to prevent the unnecessary data D15 from being used for learning. As a result, learning can be stabilized. In addition, the capacity of data to be stored in the storage device 4 can be reduced.

In addition, the unnecessary data D15 includes data corresponding to anon-occurrence state of work obstruction. This makes it possible to prevent such data from being used for learning.

In addition, the learning device 200 includes the data preprocessing unit 32 to generate the preprocessed learning data D13 by executing preprocessing on the first learning data D11, and the preprocessed learning data D13 includes the image data D14 indicating the bird's-eye view image I11 of the region R including the autonomous mobile object 1. As a result, the image data D14 can be used as an input to the learning model M′.

Further, the autonomous mobile object 1 is provided for an FA device, the dynamic obstacle O′ includes an arm of a worker in a factory having the FA device, and the correct value indicates the control amount A′ for avoiding occurrence of work obstruction to the worker by the autonomous mobile object 1. This makes it possible to avoid occurrence of work obstruction by the autonomous mobile object 1 (for example, a robot arm). As a result, the work efficiency of the worker can be improved.

In addition, the correct value indicates the control amount A′ for avoiding the occurrence of path obstruction to the dynamic obstacle O′ by the autonomous mobile object 1. As a result, for example, the occurrence of work obstruction as described above can be avoided.

In addition, the correct value indicates the control amount A′ for avoiding occurrence of collision between the autonomous mobile object 1 and the dynamic obstacle O′. As a result, for example, the occurrence of work obstruction as described above can be avoided.

Note that, in the present disclosure, it is possible to modify any component of the embodiment or omit any component of the embodiment within the scope of the disclosure.

### INDUSTRIAL APPLICABILITY

The control device and the learning device according to the present disclosure can be used for control of an autonomous mobile object.

### REFERENCE SIGNS LIST

1: autonomous mobile object, 2: information source, 3: storage device, 4: storage device, 11: learned model storing unit, 12: learning data storing unit, 21: data acquiring unit, 22: data preprocessing unit, 23: control amount calculating unit, 24: control unit, 31: data acquiring unit, 32: data preprocessing unit, 33: data selecting unit, 34: model generating unit, 41: first data acquiring unit, 42: second data acquiring unit, 43: learner, 51: processor, 52: memory, 53: processing circuit, 61: processor. 62: memory, 63: processing circuit, 100: control device, 200: learning device

1. A control device, comprising:
data acquiring circuitry to acquire inference data including moving speed information indicating a moving speed of an autonomous mobile object, relative position information indicating a relative position of a dynamic obstacle with respect to the autonomous mobile object, and relative speed information indicating a relative speed of the dynamic obstacle with respect to the autonomous mobile object;
data preprocessing circuitry to generate preprocessed inference data by executing preprocessing on the inference data, the preprocessed inference data including image data indicating a bird's-eye view image of a region including the autonomous mobile object;
control amount calculating circuitry to calculate a control amount for controlling a movement of the autonomous mobile object in response to a movement of the dynamic obstacle using the preprocessed inference data; and
control circuitry to control the movement of the autonomous mobile object using the control amount, wherein
the data preprocessing circuitry sets a size of the region indicated by the image data depending on the moving speed and the relative speed,
the control amount calculating circuitry uses a learned model by machine learning, and
the learned model receives an input of the preprocessed inference data and outputs the control amount.

2. The control device according to claim 1, wherein
the dynamic obstacle includes a manned mobile object for work or a worker, and
the learned model outputs the control amount for avoiding occurrence of work obstruction to the manned mobile object or the worker by the autonomous mobile object.

3. The control device according to claim 1, wherein
the autonomous mobile object is provided for an FA device,
the dynamic obstacle includes an arm of a worker in a factory having the FA device, and
the learned model outputs the control amount for avoiding occurrence of work obstruction to the worker by the autonomous mobile object.

4. The control device according to claim 1, wherein the learned model outputs the control amount for avoiding occurrence of course obstruction to the dynamic obstacle by the autonomous mobile object.

5. The control device according to claim 1, wherein the learned model outputs the control amount for avoiding occurrence of collision between the autonomous mobile object and the dynamic obstacle.

6. A learning device, comprising:
data acquiring circuitry to acquire first learning data including moving speed information indicating a moving speed of an autonomous mobile object, relative position information indicating a relative position of a dynamic obstacle with respect to the autonomous mobile object, and relative speed information indicating a relative speed of the dynamic obstacle with respect to the autonomous mobile object, and acquire second learning data including a correct value of a control amount for controlling a movement of the autonomous mobile object in response to a movement of the dynamic obstacle;
data preprocessing circuitry to generate preprocessed learning data by executing preprocessing on the first learning data, the preprocessed learning data including image data indicating a bird's-eye view image of a region including the autonomous mobile object; and
model generating circuitry including a learning model to receive an input of the preprocessed learning data and output the control amount, and a learner to generate a learned model by training the learning model using the second learning data, wherein
the data preprocessing circuitry sets a size of the region indicated by the image data depending on the moving speed and the relative speed,
the learned model receives an input of preprocessed inference data corresponding to inference data including the moving speed information, the relative position information, and the relative speed information, and outputs the control amount.

7. The learning device according to claim 6, wherein
the dynamic obstacle includes a manned mobile object for work or a worker, and
the correct value indicates the control amount for avoiding occurrence of work obstruction to the manned mobile object or the worker by the autonomous mobile object.

8. The learning device according to claim 7, further comprising
data selecting circuitry to select unnecessary data included in the preprocessed learning data, wherein
the unnecessary data is excluded from training of the learning model.

9. The learning device according to claim 8, wherein the unnecessary data includes data corresponding to a non-occurrence state of the work obstruction.

10. The learning device according to claim 6, wherein
the autonomous mobile object is provided for an FA device,
the dynamic obstacle includes an arm of a worker in a factory having the FA device, and
the correct value indicates the control amount for avoiding occurrence of work obstruction to the worker by the autonomous mobile object.

11. The learning device according to claim 6, wherein the correct value indicates the control amount for avoiding occurrence of path obstruction to the dynamic obstacle by the autonomous mobile object.

12. The learning device according to claim 6, wherein the correct value indicates the control amount for avoiding occurrence of collision between the autonomous mobile object and the dynamic obstacle.
